(19) United States
(12) Patent Application Publication
(10) Pub. No.: US 2005/0088001 A1
(43) Pub. Date: Apr. 28, 2005

(54) Polish pad tool

(76) Inventor: Kelley Jones, Rockdale, TX (US)

Correspondence Address: SAMSUNG AUSTIN SEMICONDUCTOR, L.P.;ATTN: TERESA J. BURROFF, ESQ., 12100 SAMSUNG BLVD., AUSTIN, TX, 78754, US

(21) Appl. No.: 10/693,089

(22) Filed: Oct. 24, 2003

(51) Int. Cl. B25B 7/02

(52) U.S. Cl. 294/16

(57) ABSTRACT

A tool for lifting a pad, such as a CMP polish pad, is provided that includes a jaw that has an upper jaw portion and a lower jaw portion. The lower jaw portion has a sloped upper surface for slidably receiving a portion of the pad. A first member is pivotally coupled to the jaw. A second member is pivotally coupled to the first member. The second member has a surface opposite to the sloped surface of the lower jaw portion. The surface is operable to clamp the portion of the pad against the sloped surface when the first member is pivoted upwards.

### BACKGROUND OF THE INVENTION

1. Field of the Invention

This invention relates generally to semiconductor processing, and more particularly to a tool for lifting a pad, such as a polish pad from a table or other surface.

2. Description of the Related Art

Chemical mechanical planarization or polishing (“CMP”) processes involve the removal of material from a surface of a wafer through the use of an abrasive slurry and various rinses and solvents. Material removal is accomplished through a combination of abrasive action and chemical reaction. In many conventional processes, a quantity of an abrasive slurry is dispensed on a polish pad of a CMP tool and spread across the surface thereof by means of centrifugal force. Thereafter, one or more wafers are brought into sliding contact with the polish pad polish pad for a selected period of time.

A typical conventional CMP polish pad consists of a disk-like piece composed of a compliant material, such as rubber. The polish pad is secured to an upper surface of a table or platen by a suitable adhesive. Not surprisingly, polish pads are subjected to tremendous wear due to the abrading action of the polishing processes, and to a lesser extent, chemical attack from the CMP slurries and solvents. The quality of wafer polishes therefore tends to decline along with the structural degradation of the polish pad. To ensure high quality wafer polishes, polish pads must be replaced at regular intervals.

One conventional method of replacing a polish pad involves the manual grasping of an edge of the polish pad by hand and thereafter peeling back the pad by brute force. Another conventional technique involves the same general procedure, albeit with the use of a pair of conventional pliers to grasp the very edge of the pad. These two conventional techniques may be, to say the least, somewhat arduous, indelicate jobs.

Another conventional technique involves the use of a pneumatic/hydraulic machine that is placed over the platen and used to mechanically lift the spent pad from the platen. This machine can be relatively expensive and is potentially incompatible with different sizes and shapes of platens, pads and other CMP apparatus.

The present invention is directed to overcoming or reducing the effects of one or more of the foregoing disadvantages.

### SUMMARY OF THE INVENTION

In accordance with one aspect of the present invention, a tool for lifting a pad is provided that includes a jaw that has an upper jaw portion and a lower jaw portion. The lower jaw portion has a sloped upper surface for slidably receiving a portion of the pad. A first member is pivotally coupled to the jaw. A second member is pivotally coupled to the first member. The second member has a surface opposite to the sloped surface of the lower jaw portion. The surface is operable to clamp the portion of the pad against the sloped surface when the first member is pivoted upwards.

In accordance with another aspect of the present invention, a chemical mechanical polishing pad removal tool is provided that includes a jaw that has an upper jaw portion and a lower jaw portion. The upper jaw portion has an arcuate lower surface for contacting portions of an upper surface of the chemical mechanical polishing pad. The lower jaw portion has a sloped upper surface spaced below and opposite to the arcuate lower surface for slidably receiving a portion of the pad. A first member is pivotally coupled to the jaw. A second member is pivotally coupled to the first member. The second member has a surface projecting below the arcuate lower surface of the upper jaw portion and positioned opposite to the sloped surface of the lower jaw portion. The second surface is operable to clamp the portion of the pad against the sloped surface when the first member is pivoted upwards.

In accordance with another aspect of the present invention, a chemical mechanical polishing pad removal tool is provided that includes a jaw that has an upper jaw portion and a lower jaw portion. The upper jaw portion has an arcuate lower surface for contacting portions of an upper surface of the chemical mechanical polishing pad. The lower jaw portion has a sloped upper surface spaced below and opposite to the arcuate lower surface for slidably receiving a portion of the pad. The sloped upper surface terminates at a lower end in a rounded nose. A handle is pivotally coupled to the jaw. A member is pivotally coupled to the handle. The member has a textured surface projecting below the arcuate lower surface of the upper jaw portion and positioned opposite to the sloped surface of the lower jaw portion. The textured surface is operable to clamp the portion of the pad against the sloped surface when the handle is pivoted upwards.

### BRIEF DESCRIPTION OF THE DRAWINGS

The foregoing and other advantages of the invention will become apparent upon reading the following detailed description and upon reference to the drawings in which:

FIG. 1 is a plan view of an exemplary embodiment of a polish pad lifting tool in accordance with the present invention;

FIG. 2 is a side view of the polish pad lifting tool depicted in FIG. 1 in accordance with the present invention;

FIG. 3 is a cross-sectional view of FIG. 1 taken at section 3-3 in accordance with the present invention; and

FIG. 4 is a magnified view of a portion of FIG. 2 that shows a portion of a pivoting member in more detail in accordance with the present invention.

### DETAILED DESCRIPTION OF SPECIFIC EMBODIMENTS

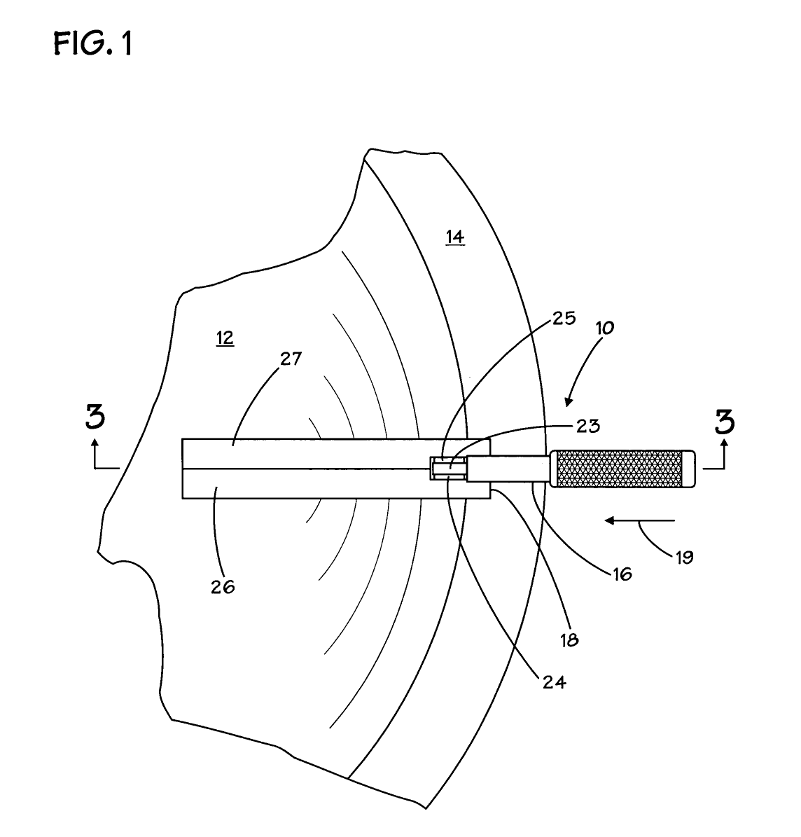

In the drawings described below, reference numerals are generally repeated where identical elements appear in more than one figure. Turning now to the drawings, and in particular to FIG. 1, therein is shown a plan view of an exemplary embodiment of a polish pad tool 10 (hereinafter “tool 10”). The tool 10 is useful for disengaging a polish pad 12 from a platen 14 or other flat surface. The polish pad 12 and the platen 14 may be of various sizes. In the illustrated embodiment, the polish pad 12 and the platen 14 are of such size that only small portions thereof are illustrated in FIGS. 1-3. The tool 10 includes a member or handle 16 and that is pivotally connected to a member or jaw 18. The handle 16 is designed to enable an operator to initially move the tool 10 in the direction of the arrow 19 to engage the pad 12. Subsequent removal of the pad 12 entails pivoting of the handle 16. In this regard, the handle 16 is pivotally connected to the jaw 18 by way of a pin 20. Optionally, the pivotal connection may be provided by a bolt, or other structural member suitable for pivotally connecting two pieces together. The member 16 may be provided with a textured portion 22 that is designed to facilitate hand grasping thereof. The texturing may be in the form of knurling, or other well-known texturing. A portion 23 of the handle 16 is configured as a tongue member to which fork tines 24 and 25 are pivotally coupled. The fork tines 24 and 25 are coupled to a foot member that is not visible in FIG. 1 but is illustrated in subsequent figures. As described below, the foot member is designed to engage the pad 12.

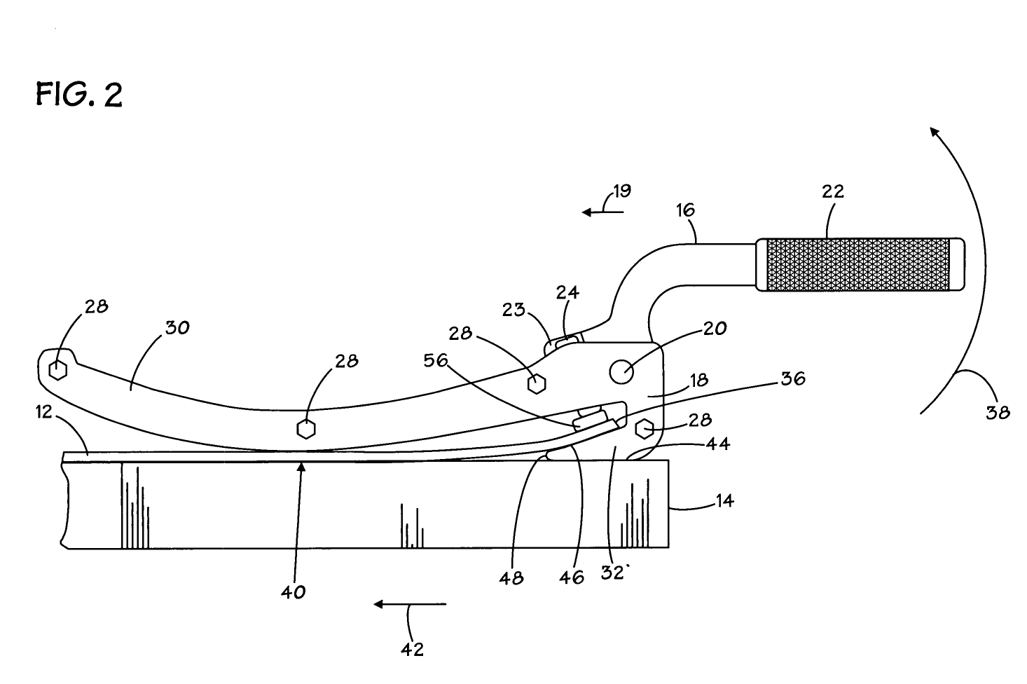

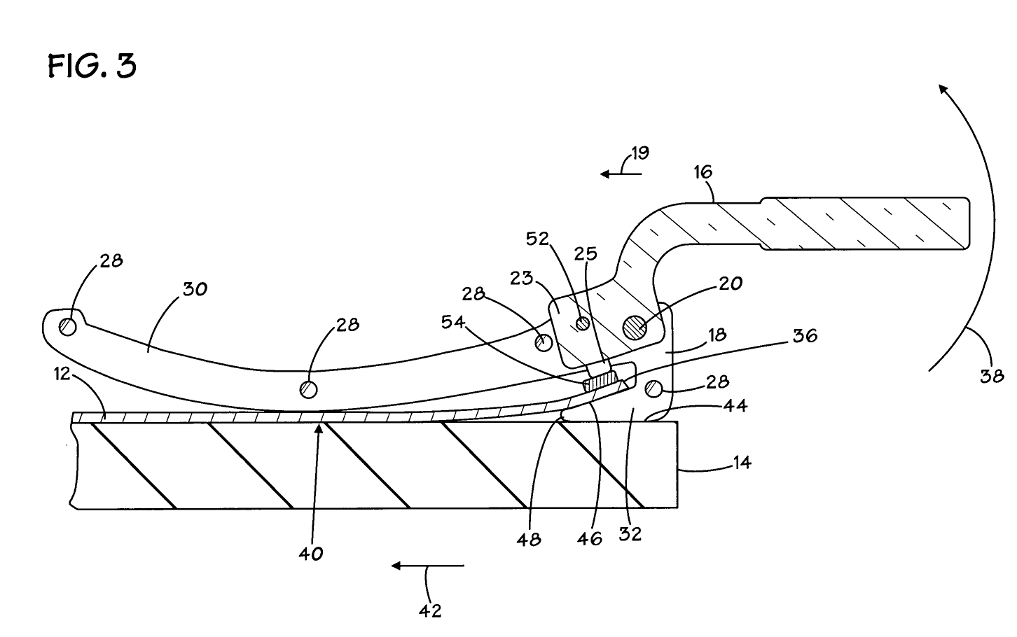

Additional details regarding the structure of the tool 10 may be understood by referring now also to FIG. 2, which is a side view of the tool 10, the polish pad 12 and the platen 14 and to FIG. 3, which is a cross-sectional view of FIG. 1 taken at section 3-3. The jaw 18 consists of respective halves 26 and 27 that are joined together by bolts 28. Optionally, other types of fastening structures, such as pins, or other well-known fastening techniques may be used to secure the halves 26 and 27 together. When joined together as shown in FIGS. 1-3, the halves 26 and 27 define an upper jaw portion 30 and a lower jaw portion 32. The upper jaw portion 30 is advantageously an elongated member that is designed to have a lower surface 34 that contacts the upper surface of the polish pad 12 at some distance from the outer edge 36 of the pad 12. The lower surface 34 is advantageously arcuate-shaped. If arcuate-shaped, a point or relatively small area of the lower surface 34 contacts and compresses the upper surface of the pad 36 against the platen 14 as the tool 10 is pivoted upward as indicated by the arrow 38 in FIG. 2. In this way, a substantial torque may be imparted to the outer periphery of the polish pad 12 to facilitate the lifting thereof off the platen 14. Note that the point, designated 40 in FIGS. 1, 2 and 3, where the lower surface 34 of the jaw portion 30 contacts the upper surface of the polish pad 12 will tend to translate in the direction of the arrow 42 as the tool 10 is pivoted upward in the direction of the arrow 38 shown in FIG. 2. This configuration, readily facilitates the progressive movement of the contact point 40 in the direction of the arrow 42 as the tool 10 is pivoted, thus producing an upward peeling movement of the polish pad 12 away from the platen 14. However, the skilled artisan will appreciate that the lower surface 34 may be less than arcuate and indeed relatively planar if desired.

The lower jaw portion 32 is advantageously provided with a relatively flat undersurface 44 that is designed to facilitate sliding movement of the tool 10 on the upper surface of the platen 14 at the time the tool 10 is brought into engagement with the outer peripheral portion 36 of the polish pad 12. The lower jaw portion 32 has an upwardly sloping ramp surface 46 that terminates at a lower end in a rounded nose or edge portion 48. The nose portion 48 is advantageously tapered down to a relatively small radius. Optionally, the nose portion 48 may be a knife edge. The purpose of the nose portion 48 is to readily slide underneath the underside of the outer edge 36 of the polish pad 12 so that the outer edge 36 may then move up the ramp surface 46 as the tool 10 is advanced in the direction of the arrow 19.

The fork tines 24 and 25 are pivotally coupled to the member 16 by a pin 52, which is only visible in FIG. 3. Note that only the tine 24 is visible in FIG. 2 and only the tine 25 is visible in FIG. 3. The tines 24 and 25 are coupled at their lower ends to a grasping member or foot 54 that is designed to engage the pad 12. The tines 24 and 25 may be integrally formed with the foot 54 or fastened thereto by well-known fastening techniques. Here again, the pin 52 may be a pin, a bolt, or other well-known structural member that facilitates pivoting movement between two members. The foot 54 has a lower surface spaced vertically from the sloped surface 46. Sufficient clearance is provided to just accommodate the thickness of the pad 12. The foot 54 is designed to compress against the upper surface of the polish pad 12 proximate the outer edge 36 thereof when the tool 10 is advanced to position the ramp portion 46 beneath the outer edge 36 and particularly when the tool 10 is pivoted upward in the direction of the arrow 38. The foot 54 may take on a myriad of shapes that facilitate clamping of the pad 12 to the sloped surface 46.

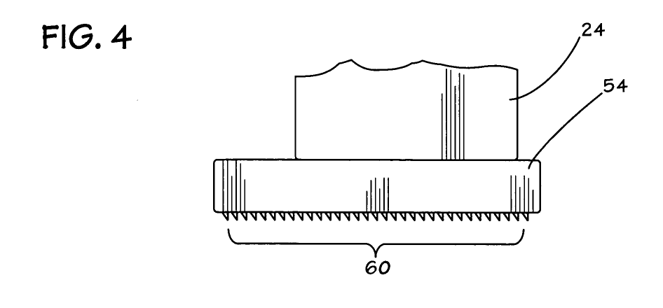

A more detailed view of the foot 54 and the tine 24 viewed from the side is depicted in FIG. 4. As shown, the foot 54 may be provided with a textured under surface 60 that facilitates a grasping engagement with the upper surface of the polish pad 12. The textured surface 60 may be in the form of knurling, or other texturing techniques as desired.

The various components that make up the tool may be composed of a variety of structural materials, such as, for example, metals, plastics, various polymeric materials with or without fiber reinforcement, combinations of these or the like. Corrosion resistance is a desirable where the tool 10 will be exposed to corrosive agents. In an exemplary embodiment, the tool 10 may be composed of aluminum.

In operation, the tool 10 is positioned such that the lower surface 44 of the lower jaw portion 18 is seated on the platen 14. The tool 10 advanced laterally until the nose portion 48 wedges under the edge 36 of the polish pad 12. Optionally, the edge 36 may be lifted slightly by hand and the nose 48 slid underneath. The tool 10 is next advanced laterally until the pad edge 36 is pushed up the sloped surface 46. As the upper surface of the pad 12 engages the foot 54, the foot 54 will pivot counterclockwise (as viewed in FIGS. 2 and 3). The tool 10 is next pivoted upwards in the direction of the arrow 38. The upward pivoting movement produces additional counterclockwise pivoting of the foot 54 and substantial clamping of the pad 12 between the foot 54 and the sloped surface 46. As the upward pivoting of the tool 10 continues, the pad 12 is progressively peeled from the platen 14. The process may be repeated at various points around the circumference of the pad 12 as necessary to completely loosen the pad 12 from the platen 14.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents and alternatives falling within the spirit and scope of the invention as defined by the following appended claims.

1. A tool for lifting a pad, comprising:
a jaw having an upper jaw portion and a lower jaw portion, the lower jaw portion having a sloped upper surface for slidably receiving a portion of the pad;
a first member pivotally coupled to the jaw; and
a second member pivotally coupled to the first member, the second member having a surface opposite to the sloped surface of the lower jaw portion and operable for clamping the portion of the pad against the sloped surface when the first member is pivoted upwards.

2. The tool of claim 1, wherein the upper jaw portion has an arcuate lower surface.

3. The tool of claim 2, wherein the jaw is arcuate.

4. The tool of claim 1, wherein the jaw comprises a first half coupled to a second half.

5. The tool of claim 1, wherein the lower jaw portion comprises a substantially flat lower surface.

6. The tool of claim 1, wherein the first member comprises a cutout in which a portion of the second member is pivotally positioned.

7. The tool of claim 1, wherein the surface of the second member comprises a textured surface.

8. A chemical mechanical polishing pad removal tool, comprising:
a jaw having an upper jaw portion and a lower jaw portion, the upper jaw portion having an arcuate lower surface for contacting portions of an upper surface of the chemical mechanical polishing pad, the lower jaw portion having a sloped upper surface spaced below and opposite to the arcuate lower surface for slidably receiving a portion of the pad;
a first member pivotally coupled to the jaw; and
a second member pivotally coupled to the first member, the second member having a surface projecting below the arcuate lower surface of the upper jaw portion and being opposite to the sloped surface of the lower jaw portion, the second surface being operable for clamping the portion of the pad against the sloped surface when the first member is pivoted upwards.

9. The tool of claim 8, wherein the jaw is acuate.

10. The tool of claim 8, wherein the jaw comprises a first half coupled to a second half.

11. The tool of claim 8, wherein the lower jaw portion comprises a substantially flat lower surface.

12. The tool of claim 8, wherein the first member comprises a cutout in which a portion of the second member is pivotally positioned.

13. The tool of claim 12, comprising a cap coupled to the first member to laterally enclose the cutout.

14. The tool of claim 8, wherein the surface of the second member comprises a textured surface.

15. A chemical mechanical polishing pad removal tool; comprising:
a jaw having an upper jaw portion and a lower jaw portion, the upper jaw portion having an acuate lower surface for contacting portions of an upper surface of the chemical mechanical polishing pad, the lower jaw portion having a sloped upper surface spaced below and opposite to the arcuate lower surface for slidably receiving a portion of the pad, the sloped upper surface terminating at a lower end in a rounded end;
a handle pivotally coupled to the jaw; and
a member pivotally coupled to the handle, the member having a textured surface projecting below the arcuate lower surface of the upper jaw portion and being opposite to the sloped surface of the lower jaw portion, the textured surface being operable for clamping the portion of the pad against the sloped surface when the handle is pivoted upwards.

16. The pad removal tool of claim 15, wherein the jaw is arcuate.

17. The pad removal tool of claim 15, wherein the jaw comprises a first half coupled to a second half.

18. The pad removal tool of claim 15, wherein the lower jaw portion comprises a substantially flat lower surface.

19. The pad removal tool of claim 15, wherein the handle comprises a cutout in which a portion of the second member is pivotally positioned.

20. The tool of claim 15, comprising a cap coupled to the first member to laterally enclose the cutout.
